(19) United States
(12) Patent Application Publication
(10) Pub. No.: US 2023/0071407 A1
(43) Pub. Date: Mar. 9, 2023

(54) METHOD FOR CUTTING A GLASS ELEMENT AND CUTTING SYSTEM

(71) Applicant: FLABEG Automotiv Gernaby GmbH, Furth im Waid (DE)

(72) Inventor: Jürgen BETZ, Bad Kreuznach (DE)

(73) Assignee: FLABEG Automotiv Gernaby GmbH, Furth im Waid (DE)

(21) Appl. No.: 17/783,633

(22) PCT Filed: Dec. 7, 2020
(86) PCT No.: PCT/EP2020/084917

§ 371 Date: Jun. 8, 2022

(30) Foreign Application Priority Data
Dec. 12, 2019 (DE) 10 2019 219 462.1

(51) Int. Cl. B23K 26/53; B23K 26/06; B23K 26/0622; B23K 26/067; B23K 26/402

(52) U.S. Cl. CPC B23K 26/53; B23K 26/0617; B23K 26/0624; B23K 26/0648; B23K 26/0676; B23K 26/402; B23K 2103/54

(57) ABSTRACT

A method for cutting a glass element (2) with a processing laser (4) is intended to enable a particularly simple process sequence with a high degree of reliability and a low level of equipment expenditure. For this purpose, according to the invention, the processing laser (4) is operated in a first processing step as a perforation laser, with which a perforation (12) is produced in the glass element (2) along an intended cutting line (8), whereby the processing laser (4) is operated in a second processing step with a modified laser beam (14) as a separating laser, with which a splitting of the filaments (6) forming the perforation (12) is effected.

### FIELD OF INVENTION

The invention relates to a method for laser cutting a glass element, in which a perforation is created in the glass element along an intended cutting line by means of a perforating laser. It further relates to the use of a laser in such a method and to a cutting system for carrying out the method.

### BACKGROUND OF INVENTION

A variety of processes and concepts can be used to cut or separate glass or glass elements. Among other things, laser-based processes such as laser filament cutting can be used, especially with regard to complex cutting shapes or high precision requirements.

Laser filament cutting, also known as filamentation, makes use of non-linear optical effects. For this purpose, a suitably selected laser—also referred to below as a “perforating laser”—is usually used, the focus of which is placed under the glass surface of the glass element to be cut and into the material. Due to the so-called self-focusing, there is local heating in the glass material at the point where the focal point is located, and the formation of local stresses and a change in the refractive index. As a result, the initially small volume element acts like a lens, and in its continuation, further such filaments can be generated. If the laser beam is guided over the glass in this process, a so-called filament curtain is created, which acts in the manner of a perforation and can serve as a starting point for a subsequent separation step, for example by breaking. This concept of laser filamentation is known, for example, from US 2013/0126573 A1.

A particularly high-quality and precise separation can be achieved with such a laser-based filament cutting process by subsequently carrying out a further treatment step with a laser for the actual separation, i.e. after the filamentation or perforation has been introduced. For example, a CO₂ laser can be used to generate localized heating in the glass material in the area of the filament track. This causes the material to break off or fracture along the contour. Such a process is particularly suitable for glasses with comparatively high thermal expansion; however, it also produces a comparatively sharp-edged and thus susceptible separating edge. Usually, therefore, after cutting or separating, further post-treatment is required, in which the separating edge is provided with a rounding or a chamfer, for example.

### SUMMARY OF INVENTION

The invention is now based on the task of specifying a process of the above-mentioned type, which enables a particularly simple process sequence with a high degree of reliability. Furthermore, a cutting system particularly suitable for carrying out the process is to be specified.

With regard to the method for cutting a glass element with a processing laser, this task is solved according to the invention in that the processing laser is operated in a first processing step as a perforation laser, with which a perforation is produced in the glass element along an intended cutting line, and in which the processing laser is operated in a second processing step with a modified laser beam as a separation laser, with which a splitting or separation of the filaments forming the perforation is effected.

The invention is based on the consideration that very good and high-quality results are often achieved in the known and usual processes of laser filament cutting, although two different laser systems and an additional intermediate working step are required in the process control. These laser filament cutting concepts are thus comparatively costly. Against this background, in order to simplify process control while maintaining the qualitative requirements, the process steps should therefore be aligned in such a way that both the introduction of the perforation in the first processing step and the induction of the actual separation in the second processing step can be carried out with one and the same laser. However, in view of the different requirements for interaction with the (glass) substrate in both processing steps, this is not easily possible with a known laser system. In order to take this into account, it is now intended to modify the laser beam in the second processing step so that the desired separation is possible using the same laser that is also used to make the perforation in the substrate.

Advantageous embodiments of the invention are the subject of the subclaims.

Advantageously, an ultrashort pulse (UKP) laser is used as the processing laser, as is known in principle for the generation of filamentary damage in a glass substrate, for example from WO 2018/130448 A1. Ultra-short pulse lasers are in particular laser beam sources which emit pulsed laser light with pulse durations in the range of picoseconds and femtoseconds. In a particularly preferred embodiment, a solid-state laser, preferably an Nd:YAG laser with a wavelength of 1064 nm or with frequency doubling (corresponding to a green laser color), can be provided for this purpose.

Particularly advantageous is the splitting of the filaments forming the perforation during the separation by ablative laser processing. In this case, the processing laser is preferably operated in its function as a separating laser in the second processing step in such a way that, as a result of the action of the laser beam on the glass substrate, a notch is created by laser ablation in the area of the previously introduced perforation or the filaments forming it. With increasing ablation of the notch, in a particularly advantageous embodiment, an expanding plasma is created in the notch, the expansion pressure of which is preferably controlled by suitable control and tracking of the laser parameters in such away that the forces acting on the edges of the notch as a result of the expansion pressure cause the glass element to split in the area of the filaments or modifications.

In order to enable the intended use of the perforation laser also as a cutting laser in the second processing step, a suitable modification or beam shaping of the laser beam is provided in a particularly advantageous embodiment in the second processing step. Surprisingly, it has been found that a reliable control of the expansion pressures in the plasma as well as the position of the plasma in the notch and the thus exerted splitting forces is very important for a high-quality cutting result with particularly low damage to the cutting edge, such as shells or cracks. Such comparatively precise control is not sufficient for the single laser beam actually delivered by the processing laser; this could lead to premature breakage of the edge. To counteract this and to enable a particularly high-quality cutting result, the laser beam of the processing laser is advantageously divided into a plurality of, preferably six, parallel partial beams by beam shaping in the second processing step.

In a particularly advantageous further development, the beam is shaped by means of a diffractive optical element (DOE) that can be swiveled into the beam path of the processing laser. This splits the incident primary beam into a number of secondary laser beams and refocuses them. According to the grating structure of the first DOE, a pattern with focal points in the line results; according to the second or further DOEs, a focus matrix is obtained on or below the glass surface, depending on the spatial arrangement. By rotating or laterally moving the DOEs, the contour-adapted focus matrix can be realized. As a result, the DOE can be used to suitably adjust the beam shaping, which in turn can be used to suitably control the expansion pressures of the plasma and the position of the plasma in the notch. The beam shaping by means of the DOE also simultaneously fulfils the task of the lateral arrangement of the laser beams for cutting contours, for example a triangular arrangement in which the beams act like a curve of constant width or polygon with a constant diameter in all directions. Here, the adapted focus matrix with focal points of different intensity and spatial position (beam shaping) influences the formation of the process-related, laser-induced plasma. As a result of the plasma composition, density, temperature and position in the filament curtain, the intended expansion pressure for the split towards and along the filaments in the glass body is created.

With regard to the cutting system, the above-mentioned task is solved with a processing laser into whose beam path a beam shaping element, advantageously designed as a diffractive optical element, can be pivoted.

The advantages achieved with the invention consist in particular in the fact that by using one and the same processing laser in both processing steps, i.e. in the generation of the filaments and the perforation formed by them as well as in the subsequent separation, a clear simplification of the process control and also of the equipment expenditure for the process of laser cutting can be achieved with unchanged high processing and production quality. The separating edges that can be produced in this process have a high edge sharpness and quality, and especially for the separation of comparatively thick materials and/or contours with comparatively small dimensions, the concept of separation by mechanical forces by using the expansion pressure of the plasma in the resulting notch is very advantageous.

### BRIEF DESCRIPTION OF THE DRAWINGS

An embodiment of the invention is explained in more detail with reference to a drawing. Therein:

FIG. 1 schematically shows a cutting system for cutting glass elements,

FIG. 2 shows a beam shaping element of the cutting system according to FIG. 1,

FIG. 3 shows a glass element with inserted filaments, and

FIG. 4 shows the edge profile of a separating edge of the glass element according to FIG. 3.

Identical parts are marked with the same reference signs in all figures.

### DETAILED DESCRIPTION OF THE DRAWINGS

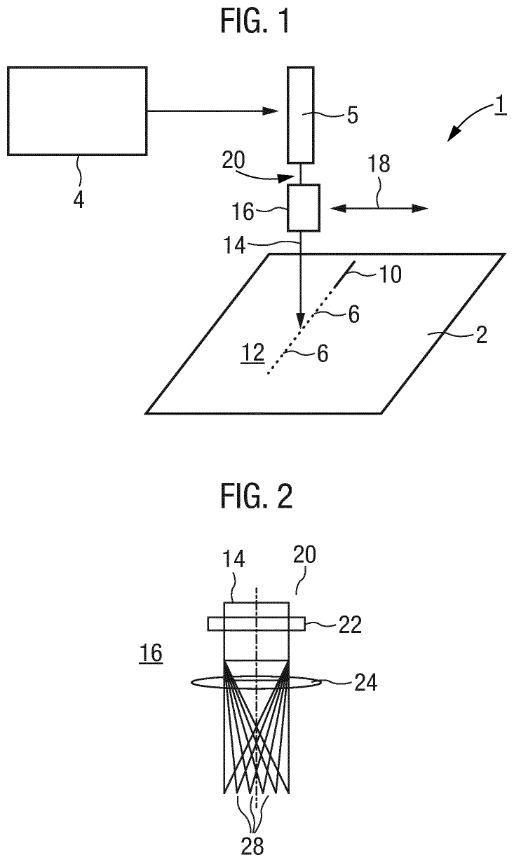

The cutting system 1 according to FIG. 1 is provided for cutting glass elements 2 by laser filament cutting. For this purpose, the cutting system 1 comprises a processing laser 4, which is basically and by design designed as a perforation laser suitable for filamentation and is guided via an FI optic 5 in the direction towards the glass element 2. As a result of the design of the processing laser 4 during operation as a perforation laser, local heating occurs in the material of the glass element 2 at the point where the focal point is located, the formation of local stresses and a change in the refractive index, so that ultimately, as a result of non-linear optical effects in the glass material, elongated disturbances, or modifications, also referred to as filaments 6, are produced. The processing laser is controllable via an associated control device not shown in more detail. Via the control by means of the control device 8, the focal point of the processing laser 4 can be guided along a predeterminable cutting line 10 on the surface of the glass element 2 to be cut. The filaments 6 which form the desired perforation 12 are thus created along this cutting line 10.

When guiding the laser beam 14 of the processing laser 4, its point of impact on the glass element 2 and/or its focus point is suitably guided. In the context of the control, the focus position can be used in particular as a parameter for calculation in CNC data, since this is usually easy to describe. The focus position could be in, below, or above the material of the glass element 2 in order to enable two-dimensional processing by the laser light.

For the actual cutting of the glass element 2, i.e. for the separation of the parts along the cutting line 10 and the perforation 12, a further processing step is provided downstream of the filamentation in the first processing step, i.e. after insertion of the perforation 12. The cutting system 1 is designed for a particularly efficient and cost-saving mode of operation when carrying out the cutting or separating process. In particular, the fact that two different laser systems are usually used in the laser filament cutting process is taken into account, whereby so far one of the lasers is specifically designed as a perforation laser and the other laser is designed as a separation laser for use in the subsequent separation cut. In order to specifically avoid the potentially considerable additional equipment and process costs involved, the processing laser 4 in the cutting system 1 is designed and intended for use both during the first processing step, which is intended for producing the perforation, and during the second processing step, which is intended for the actual separation. For a particularly efficient process control, the cutting system 1 is thus designed in the manner of a combined design of the processing laser 4 in such a way that the filaments 6 are produced in the glass substrate 2 with the processing laser 4 in the first processing step, whereby in a second processing step the laser beam 14 of the processing laser 4 is reshaped by means of a DOE (“diffractive optical element”) optical system 16 provided as a beam shaping element, and the filaments 6 are irradiated again with it. This generates a plasma in the area of the filaments 6; the resulting pressure causes the separation of the elements.

In order to be able to switch in a comparatively simple manner between the modes of operation of the processing laser 4 as a perforating laser on the one hand and a separating laser on the other hand, the DOE optics 16 provided as a beam shaping element is pivotably mounted by means of a suitable suspension as indicated by the double arrow 18 and can be pivoted into and out of the beam path 20 of the processing laser 4. Alternatively or additionally, the DOE optics 16 can be arranged downstream of the laser 4 parallel to the FI optics 5, whereby a beam switch switches the laser output beam between FI optics 5 and DOE optics 16.

The structure of the DOE optics 16 provided as a beam shaping element is shown schematically in FIG. 2 when swiveled into the beam path 20. The element or the DOE optics 16 comprises the actual diffractive optical element 22 and, downstream of this in the beam path 20, a lens 24. The interconnection of these components is provided in the embodiment example in such a way that the collimated laser beam 14 impinging on the element 16 is divided into six secondary laser beams or partial beams 28. For the wavelength of 1064 nm of the processing laser 4 provided in the embodiment example, this results in six partial beams 28 with a distance to each other of about 10 μm. The transmission of the laser radiation for the element 16 is 97%, and the six partial beams 28 with the same intensity have a total share of the supplied laser power of 86%.

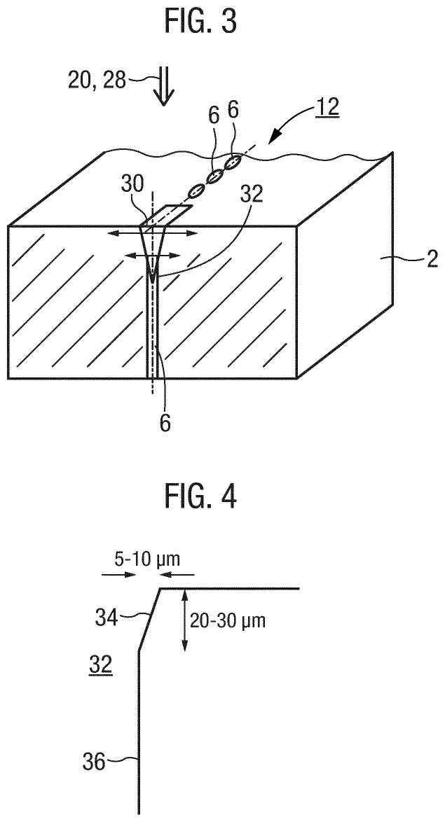

As can be seen from the enlarged sectional representation of the glass element 2 in FIG. 3 during the phase of the second processing step, the processing laser 4 is operated as an ablation laser in its function as a separating laser in the area of the filaments 6 already set in the glass element. As a result of the action of the laser beam 14 formed in the element 16 and composed of the aforementioned six partial beams 28 on the glass substrate 2, a notch 30 is formed by laser ablation in the region of the previously introduced perforation 12 or of the filaments 6 forming this perforation. With increasing ablation of the notch 30, an expanding plasma is formed in the notch 30. With a suitable shape and geometry of the notch 30, the expansion pressure of this plasma can be used to cause the cleavage of the glass element 2 in the area of the filaments 6 or modifications as a result of the forces acting on the edges of the notch 30.

This mode of operation is ensured in particular by suitable control and tracking of the laser parameters. Surprisingly, it has been found that the beam shaping of the incident laser beam 26 is also important for reliable use of the expansion pressure to break the glass element 2: Beam shaping is required to build up the desired pressure in the notch 30, since a single beam would destroy the material at the intensity or energy density required to form the plasma. In addition to the plasma formation (intensity), the length and position of the acting plasma in the notch 30 also plays an important role for reliable separation.

The edge profile of the separating edge 32 produced by this separating process is shown in FIG. 4. In its upper region, as seen from the surface of the glass element 2 to a depth of about 20-30 μm, the separating edge 32 has a bevel 34 delimiting the notch 30, which is followed by a comparatively straight fracture wall 36 as seen into the depth of the substrate.

### LIST OF REFERENCE SIGNS

1 cutting system
2 glass element
3 processing laser
4 FI optics
5 filament
10 cutting line
12 perforation
14 laser beam
16 DOE optics
18 double arrow
20 beam path
22 diffractive optical element
24 lens
28 partial beams
30 notch
32 separating edge
34 bevel
36 fracture wall

1. A method for cutting a glass element with a processing laser, in which the processing laser is operated in a first processing step as a perforation laser, with which a perforation is produced in the glass element along an intended cutting line, and in which the same processing laser is operated in a second processing step with a modified laser beam as a separating laser, with which a splitting of the filaments forming the perforation is effected, the filaments forming the perforation being split by ablative laser processing, characterized in that a laser beam of the processing laser is split in the second processing step by beam shaping into a plurality of partial beams, a notch with a bevel being produced in the second processing step in a region of the previously introduced perforation by ablative laser processing.

2. The method of claim 1, in which an ultrashort pulse laser is used as the processing laser.

3. The method of claim 1, in which the laser beam of the processing laser is divided into six partial beams by beam shaping in the second processing step.

4. The method of claim 1, in which a plasma is generated in the glass element by the processing laser during operation as a separating laser.

5. The method of claim 1, wherein a beam shaping element is pivoted into a beam path of the processing laser for the second processing step.

6. The method of claim 5, wherein a diffractive optical element is used as the beam shaping element.

7. (canceled)
